(19) United States
(12) Patent Application Publication
(10) Pub. No.: US 2019/0010819 A1
(43) Pub. Date: Jan. 10, 2019

(54) TURBOMACHINE SEALING ELEMENT

(71) Applicant: MTU Aero Engines AG, Munich (DE)

(72) Inventors: Alexander Ladewig, Bad Wiessee (DE); Christian Liebl, Bockhorn (DE); Steffen Schlothauer, Erdweg (DE); Johannes Casper, Muenchen (DE); Andreas Jakimov, Fahrenzhausen (DE); Klaus Semmler, Dachau (DE); Richard Scharl, Karlsfeld (DE)

(73) Assignee: MTU Aero Engines AG, Munich (DE)

(21) Appl. No.: 16/027,819

(22) Filed: Jul. 5, 2018

(30) Foreign Application Priority Data
Jul. 7, 2017 (DE) 10 2017 211 643.9

(51) Int. Cl. F01D 11/12; F01D 11/00; F16J 15/44

(52) U.S. Cl. CPC F01D 11/12; F01D 11/001; F16J 15/444; F05D 2230/53; F05D 2240/55; F05D 2220/323; F05D 2300/17

(57) ABSTRACT

The present invention relates to sealing element for sealing a radial gap relative to a counter element of a turbomachine, wherein the sealing element has a number of adjacent cells in the peripheral direction and/or in the axial direction, which are joined to one another by common walls, wherein an extension of a least one, in particular front-side, cross section of at least one cell in a first axial section of the sealing element in the peripheral direction and/or in the axial direction for sealing against a radial flange of the counter element is smaller than that in a second axial section of the sealing element that adjoins the first axial section upstream and/or in a second axial section that adjoins the first axial section downstream.

The present invention relates to a sealing element for sealing a radial gap with respect to a counter element of a turbomachine, an arrangement for a turbomachine, and a turbomachine having a sealing element, as well as a method for manufacturing the sealing element.

Known from US 2009/0041610 A1 is a honeycomb seal produced by metal(lurgical) injection molding (MIM), the cells of which have different geometric shapes in the axial direction.

Known from DE 10 2014 208 801 A1 is a sealing segment for sealing a radial gap between a rotor and a stator of a turbomachine, which is produced layer-by-layer by a free-forming method, and has an edge zone in which a plurality of predefined weakening regions are formed.

An object of an embodiment of the present invention is to improve a sealing element for sealing a radial gap with respect to a counter element of a turbomachine and/or the manufacture thereof.

This object is achieved by a sealing element having the features of claims 1, 5, and/or 9, and a method having the features of claim 18. Claims 16, 17 afford patent protection to an arrangement or a turbomachine having (at least) one sealing element described here. Advantageous embodiments of the invention are the subjects of the dependent claims.

In accordance with one embodiment of the present invention, a sealing element that is provided or set up or used for sealing and, in particular, labyrinth sealing, of a radial gap with respect to a counter element (which can move with respect to the sealing element) of a turbomachine has a number of cells, which are adjacent in the peripheral direction and/or in the axial direction, which are joined to one another, in particular in pairs, through common walls.

In one embodiment, one or a plurality, in particular at least the majority, of the cells (each) has or have an open front side facing the gap and/or a closed cell bottom facing away from the gap, and/or polygonal, in particular hexagonal, in particular honeycomb-shaped, cross sections in part, particularly at least largely, over their entire radial height. Additionally or alternatively, in one embodiment, one or a plurality, in particular the majority, of the cells or honeycombs is or are (each) joined through their six walls to six neighboring cells, with each of which they have one of these walls in common. In one embodiment, the sealing element is accordingly a honeycomb seal, in particular, which is especially advantageous for sealing radial gaps in turbomachines.

In one embodiment, the sealing element is a sealing ring that is segmented in the peripheral direction into two or more segments or is a segment of such a ring. In this way, in one embodiment, the manufacture and/or mounting is/are improved.

The directional specification “axially” or “axial direction” refers in the present case, in particular, in the technically conventional way, to a direction that is parallel to a rotational or (main) machine axis of the turbomachine; the directional specification “peripheral direction” refers correspondingly to a rotational direction of the turbomachine; and the directional specification “radially” or “radial direction” refers correspondingly to a direction that is perpendicular to the axial direction and the peripheral direction.

In one embodiment, one or a plurality, in particular at least the majority, of the cells will be or is/are (each) integrally formed or produced with a housing element or a rotor element or is/are joined detachably in a nondestructive manner, or not detachably in a nondestructive manner, to a housing element or a rotor element, in particular a vane platform or a seal carrier, of the turbomachine, in particular in a material-bonded, friction-fitting, and/or form-fitting manner.

Through an integral manufacture, it is possible, in one embodiment, to improve, in particular, the strength and/or the weight. Through a separate manufacture and subsequent attachment to the housing or to the rotor element, it is possible, in particular, to improve the manufacture and/or mounting. Preferably, the sealing element is on the housing side or fixed in place on the housing side and the counter element is correspondingly on the rotor side or fixed in place on the rotor side.

In one embodiment, the cells are or will be manufactured, at least in part, by a free-forming, in particular additive, method and/or, at least in part, from metal, in particular a nickel-based and/or a cobalt-based alloy.

Metals, in particular a nickel-based and/or a cobalt-based alloy, are suitable, in particular, for use in gas turbines. Through a free-forming, in particular additive, method, it is possible to manufacture advantageously the forms and/or variants of the cells discussed below, in particular honeycombs. In one embodiment, the free-forming or additive method comprises the layer-by-layer local and selective, in particular optical, thermal, and/or chemical, solidification and/or bonding of starting material, in particular bulk starting material, in particular pasty, liquid, and/or free-flowing starting material, in particular granular or powdered starting material, in particular layer-by-layer local and selective soldering, sintering, melting, or the equivalent. In this regard, reference is additionally made to DE 10 2014 208 801 A1 mentioned in the introduction and the content thereof is included in the present disclosure.

In accordance with one embodiment of the present invention, an arrangement for a turbomachine, in particular a compressor stage or turbine stage for a gas turbine, in particular an aircraft engine or of an aircraft engine, in particular at least one arrangement of a turbomachine, in particular at least one compressor stage or turbine stage of a gas turbine, in particular an aircraft engine or of an aircraft engine has (in each case) a counter element and a herein described sealing element fixed in place at the housing or at the rotor for sealing a radial gap with respect to the counter element, which is fixed in place with respect to the rotor or housing and accordingly moves relative to the sealing element. This represents an especially advantageous application of the present invention.

In accordance with one aspect of the present invention, an extension in the peripheral direction and/or axial direction, in particular a maximum, intermediate, and/or minimum extension, in particular a size, of one cross section or a plurality of cross sections, in particular of an (at least one) front-side cross section, of one or a plurality, in particular the majority, of the cells in a first axial section of the sealing element, which is provided or set up or used for sealing against a radial flange, in particular a tip or front surface of a so-called sealing fin, of the counter element, in particular in the case of a rotor at standstill and/or in a design operating state of the turbomachine, and is radially opposite-lying or closest-lying or neighboring to a radial flange, in particular a tip or front surface of a sealing fin, of the counter element, is smaller than (an extension, in particular the same or corresponding and/or maximum, intermediate, and/or minimum extension, in the peripheral direction and/or axial direction, in particular a size, of one a plurality of cross section(s), in particular corresponding cross section(s), in particular an (at least one) front-side cross section, of one or a plurality of, in particular at least the majority, of cells) in a second axial section that axially adjoins said first axial section upstream and/or in a second axial section of the sealing element that axially adjoins the first axial section downstream.

In this way, in one embodiment, through the finely meshed cell arrangement, a sealing against the radial flange or sealing fin is improved and, at the same time, in at least one axially adjacent region with a lower weight, an emergency mode sealing is made available in the event of excessive axial displacement of the counter element and/or a cavity is partially filled and thus, in particular, the pumping of a compressor is reduced or improved.

In one embodiment, an extension, in particular a maximum, intermediate, and/or minimum extension in the peripheral direction and/or axial direction, in particular a size, of one or a plurality of cross section(s), in particular an (at least one) front-side cross section, of one or a plurality, in particular, at least the majority, of the cells in another first axial section of the sealing element, which is provided or set up or used for sealing against another radial flange, in particular a tip or front surface of another sealing fin, of the counter element, in particular in the case of a rotor at a standstill and/or in a design operating state of the turbomachine, and is radially opposite-lying or closest-lying or neighboring another radial flange, in particular a tip or front surface of another sealing fin, of the counter element, is smaller than (an extension, in particular the same or corresponding and/or maximum, intermediate, and/or minimum extension in the peripheral direction and/or axial direction, in particular a size, of one or a plurality of cross section(s), in particular corresponding cross section(s), in particular an (at least one) front-side cross section, of one or a plurality of, in particular, at least the majority, of cells) in a second axial section that axially adjoins said additional first axial section upstream and/or in a second axial section of the sealing element that axially adjoins said additional first axial section downstream.

In this way, in one embodiment, the aforementioned advantages can also be achieved for counter elements with two or more radial flanges or sealing fins and, accordingly, the sealing effect can be improved.

In one embodiment, an axial length, in particular a maximum, intermediate, and/or minimum axial length, of the first axial section and/or of the additional first axial section is at least 110% and/or at most 300% of an axial length of a front side of said opposite-lying radial flange of the counter element, and/or at least 50% and/or at most 300% of the adjoining upstream and/or downstream second axial section.

In this way, in one embodiment, it is possible to advantageously compensate for regular axial displacements of the counter element in (normal) operation, and, at the same time, in the case of a lower weight, to make available an emergency mode sealing in the event of excessive axial displacement of the counter element, and/or a cavity is partially filled and thus, in particular, the pumping of the compressor is reduced or improved.

In one embodiment, the extension, in particular a maximum, intermediate, and/or minimum extension, in particular a size, of one cross section or a plurality of cross sections, in particular (at least) one front-side cross section of one or a plurality, in particular the majority, of the cells in the first axial section and/or in the additional first axial section in the peripheral direction and/or axial direction is at most 95%, in particular at most 80%, and/or at least 25%, in particular at least 50%, of a, in particular the same or corresponding and/or maximum, intermediate, and/or minimum, extension in the peripheral direction and/or axial direction, in particular a size, of one cross section or a plurality of, in particular corresponding, cross sections, in particular an (at least one) front-side cross section, of one or a plurality, in particular at least the majority, of the cells in the adjoining upstream and/or downstream second axial section.

In this way, in one embodiment, it is possible advantageously to improve a sealing against the radial flange or sealing fin and, at the same time, in the case of a lower weight, to make available an emergency mode sealing in the event of excessive axial displacement of the counter element, and/or a cavity is partially filled and thus, in particular, the pumping of the compressor is reduced or improved.

In accordance with another aspect of the present invention, which can be combined in a first embodiment with the above-discussed aspect of the different extensions or else can be realized independently or without said first embodiment, one free wall or a plurality of free walls of one or a plurality, in particular at least the majority, of the cells and/or one common wall or a plurality of common walls of two or more cells, in particular at least the majority of (pairwise) common walls of the cells, is or are (each) inclined in the peripheral direction and/or in the axial direction at least in a radial wall section.

In this way, in one embodiment, a sealing effect and/or a rubbing of the counter element can be improved.

In one embodiment, the wall is inclined or the walls or some of the walls are inclined against the wall section (in each case) in a direction of movement of the counter element relative to the sealing element (direction of relative movement), in particular, thus in the rotational direction of the turbomachine or the direction of rotation of the rotor thereof. In this way, in one embodiment, it is possible to improve, in particular, a rubbing of the counter element.

In an embodiment, the wall is inclined or the walls or some of the walls are inclined against the wall section (in each case) against (opposite to) a direction of movement of the counter element relative to the sealing element (direction of relative movement), thus, in particular against (opposite to) the rotational direction of the turbomachine or the direction of rotation of the rotor thereof. In this way, in one embodiment, it is possible to improve, in particular, a sealing effect.

In one embodiment, the wall is inclined or the walls or some of the walls are inclined against the wall section (in each case) in a direction of through-flow of the turbomachine. In this way, in one embodiment, it is possible to improve, in particular, a rubbing of the counter element.

In one embodiment, the wall is inclined or the walls or some of the walls are inclined against the wall section (in each case) against (opposite to) a direction of through-flow of the turbomachine. In this way, in one embodiment, it is possible to improve, in particular, a sealing effect.

In one embodiment, the radial wall section against which the wall or the walls or some of the walls is/are inclined extends from a front face of the wall facing the gap and/or from a bottom of the cell facing away from the gap and/or over at least 5%, in particular at least 25%, in particular at least 60%, of a radial wall height of the wall, in particular over, at least largely, the entire radial wall height or from a bottom that faces a gap to a front side of the wall facing away from the gap.

In this way, in one embodiment, it is possible to improve a sealing effect and/or a rubbing of the counter element.

In one embodiment, a front side of the wall or of the walls or some of the walls facing the gap is displaced (in each case) in the peripheral direction and/or axial direction by at least 1%, in particular at least 2%, in particular at least 10%, and/or at most 100%, in particular at most 50%, in particular at most 25%, of a radial wall height with respect to a connection cross section of the wall with a or the bottom of the cell.

In this way, in one embodiment, it is possible to improve a sealing effect and/or a rubbing of the counter element.

According to another aspect of the present invention, which can be combined in one embodiment with one or both of the above-discussed aspects of the different extensions or inclined walls or else can be realized independently of them, one free wall or a plurality of free walls of one or a plurality, in particular at least the majority, of the cells and/or one common wall or a plurality of common walls of two or more cells, in particular at least the majority or (pairwise) common walls, (each) have a, in particular contiguous, first radial wall section and an adjoining, in particular contiguous, second wall section that is radially closer to the gap, the maximum wall thickness of which is less than the maximum wall thickness of said first wall section, and/or a front side facing the gap, the (front) surface of which is smaller in area than a (cross section) surface of at least one cross section that is parallel to said front side or front surface, of a radial wall section that is radially further away from the gap.

Through a reduction in a maximum wall thickness of a wall section that is closer to the gap and/or of the area of a front surface with respect to a cross section that is further away from the gap, it is possible, in one embodiment, to improve a rubbing of the counter element and/or a stability of the cell(s), in particular of the area further away from the gap and, in one embodiment, advantageously to prevent or reduce the probability of any bursting or disintegration into fragments, in particular because, for the rubbing, the maximum wall thickness of a wall section closer to the gap, on the one hand, and a front surface, on the other hand, are especially relevant.

In one embodiment, the cross-sectional area and/or the maximum wall thickness of the wall or of the walls or of some of the walls in at least one tapered wall section, in particular in the second wall section, decreases toward a front side of the wall facing the gap, in particular toward the front side, and/or decreases monotonically, in particular strictly monotonically.

In this way, in one embodiment, it is possible to improve the manufacture and/or stability of the sealing element and/or a rubbing of the counter element.

In one embodiment, the tapered or second wall section of the wall or of the walls or of some of the walls extends out (in each case) from a front face of the wall facing the gap and/or over at least 1%, in particular at least 2%, in particular at least 5%, and/or at most 50%, in particular at most 25%, in particular at most 10%, of a radial height of the wall and/or of the first wall section or wall section that is further away from the gap of the (respective) wall of a bottom of the cell facing away from the gap and/or over at least 50%, in particular 75%, in particular at least 90%, and/or at most 99%, in particular at most 98%, in particular at most 95%, of a radial height of the wall.

In this way, in one embodiment, it is possible to improve a stability of the sealing element and/or a rubbing of the counter element.

In one embodiment, the maximum wall thickness of the wall or of the walls or of some of the walls in the tapered and/or second wall section is (in each case) at most 90%, in particular at most 75%, in particular at most 60%, and/or at least 10%, in particular at least 25%, in particular at least 40%, of the maximum wall thickness of the wall in the first wall section. Additionally or alternatively, in one embodiment, the (front) area of the front side of the wall or of the walls or of some of the walls is (in each case) at most 90%, in particular at most 75%, in particular at most 60%, and/or at least 10%, in particular at least 25%, in particular at least 40%, of the (cross section) area of at least one cross section parallel to it in the wall section further away from the gap, in particular of the maximum, minimum, and/or intermediate (cross section) area in the wall section further away from the gap.

In this way, in one embodiment, it is possible to improve a stability of the sealing element and/or a rubbing of the counter element.

Additional advantageous enhancements of the present invention ensue from the dependent claims and the following description of preferred embodiments. Shown for this purpose, partially schematized, are:

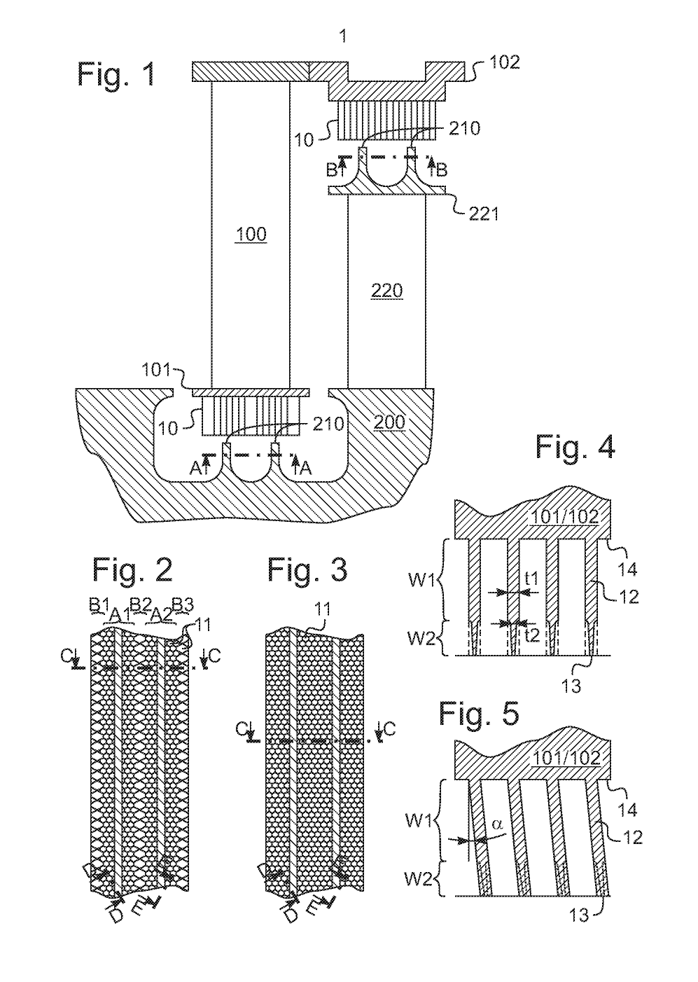

FIG. 1 a meridional section of a turbomachine with sealing elements in accordance with embodiments of the present invention;

FIG. 2, 3 a section along line A-A and/or B-B in FIG. 1; and

FIG. 4, 5 enlarged partial sections along line C-C, D-D, and/or E-E in FIG. 2 or FIG. 3.

FIG. 1 shows a meridional section of a row of guide vanes and a row of rotating blades of a compressor stage or turbine stage of a gas turbine according to the invention, in which lies a rotational or main machine axis of the gas turbine (horizontal in FIG. 1).

The row of guide vanes has guide vanes 100 with radially inner platforms 101, which are formed integrally with a sealing element according to the invention in the form of a honeycomb seal 10 or is joined to it in a material-bonded, friction-fitting, and/or form-fitting manner. The honeycomb seal 10 seals a radial gap with respect to a rotor 200 with two sealing fins 210 that are axially spaced apart.

The rotor-fixed row of rotating blades has rotating blades 220 with radially outer platforms 221 with two sealing fins 210 that are axially spaced apart. A housing-fixed seal mount 102 is formed integrally with a sealing element according to the invention in the form of a honeycomb seal 10 or is joined to it in a material-bonded, friction-fitting, and/or form-fitting manner and seals a radial gap with respect to a rotor-fixed counter element 200 or 220.

This compact and in part schematized illustration indicates preferred possibilities of application of the present invention, without limiting the application to these.

As can be seen in the sections of FIGS. 2, 3, in particular, the sealing element 10, which is segmented in the peripheral direction, but can also extend integrally over 360°, has a number of honeycombs 11 that are adjacent to one another in the peripheral direction (vertical in FIGS. 2, 3) and in the axial direction (horizontal in FIGS. 1-3), which are or will be manufactured through a free-form, in particular additive, method and/or from metal, in particular a nickel-based and/or a cobalt-based alloy, and each of which has six walls 12, an open front side 13 facing the gap, and a closed bottom 14 (see FIGS. 4, 5) that faces away from the gap and is formed integrally with or is joined to the guide vane platforms 101 or to the seal carrier 102. Honeycombs that are adjacent to one another in the peripheral direction and axial direction are each joined in pairs through common walls 12.

A first aspect of the present invention will be explained below with reference to the section in FIG. 2, which can equally illustrate a section along line A-A and/or line B-B in FIG. 1. In other words, in one embodiment, FIG. 2 represents a section only along line A-A in FIG. 1, in another embodiment a section only along line B-B in FIG. 1, and in another embodiment a section both along line A-A and—if need be, scaled—also a section along line B-B.

As can be seen in the section of FIG. 2, an extension or size in the peripheral direction and in the axial direction of front-side cross sections of honeycombs 11 in a first axial section A1 of the sealing element 10 for sealing against one of the radial flanges 210 of the counter element 200 or 220 is smaller than that in a second axial section B1 that adjoins said first axial section A1 upstream and in a second axial section B2 of the sealing element 10 that adjoins the first axial section A1 downstream. In addition, an extension or size in the peripheral direction and in the axial direction of front-side cross sections of honeycombs 11 in another first axial section A2 of the sealing element for sealing against the other or additional radial flange 210 of the counter element 200 or 220 is smaller than that in the second axial section B2 of the sealing element 10 that adjoins said additional first axial section A2 upstream and in a second axial section B2 that adjoins said additional first axial section A2 downstream.

A second aspect of the present invention will be explained below with reference to the section in FIG. 5, which can equally represent a section along line C-C, D-D, and/or E-E in FIG. 2 or 3.

In other words, in one embodiment, FIG. 5 represents a section along line C-C in FIG. 2, in one embodiment, additionally or alternatively, a section—if need be, scaled—along line D-D and/or a section—if need be, scaled—along line E-E in FIG. 2. In another embodiment, FIG. 5 represents a section along line C-C in FIG. 3, in one embodiment, additionally or alternatively, a section—if need be, scaled—along line D-D and/or a section—if need be, scaled—along line E-E in FIG. 3.

Accordingly, in one embodiment in which FIG. 5 represents a section along line

C-C, D-D, and/or E-E in FIG. 2, the second aspect explained below is combined with the above-explained first aspect of the honeycomb sizes varying in the axial direction.

In another embodiment in which FIG. 5 represents a section along line C-C, D-D, and/or E-E in FIG. 3, the second aspect explained below is realized with homogeneous or (also) equally large honeycombs or without the previously explained first aspect.

As can be seen in the section in FIG. 5, common walls 12 of the honeycombs 11 are inclined in the peripheral direction (compare FIG. 5 as a section along line D-D and/or E-E in FIG. 2 or 3) in or opposite to a direction of movement of the counter element 200 or 220 relative to the sealing element 10 and/or in the axial direction (compare FIG. 5 as a section along line C-C in FIG. 2 or 3) in or opposite to a through-flow direction of the row of guide vanes or row of rotating blades over its entire wall height W1+W2 by an angle α, so that the front sides 13 of the walls that face the gap are displaced in the peripheral direction and in the axial direction with respect to a connection cross section of the wall 12 with the bottom 14 of the honeycomb 11.

In the exemplary embodiment, the walls 12, which extend solely in the peripheral direction, are thereby inclined only in the axial direction (compare the section along line C-C in FIGS. 2 and 3), whereas the other walls 12 of the honeycombs 11 that are at an angle to said walls (compare the section along line D-D and E-E in FIGS. 2 and 3) are inclined both in the peripheral direction and in the axial direction or their front sides 13 are displaced in the peripheral direction and in the axial direction.

When, in a modification that is not illustrated, the walls 12 of the honeycombs 11 extend solely in the axial direction, they are inclined, in one embodiment, only in the peripheral direction in or opposite to a direction of relative movement of the counter element 200 or 220. For this purpose, for example, the honeycombs and lines of section of FIG. 3 are to be rotated by 90°.

A third aspect of the present invention will be explained below with reference to the extended and continuous section of FIG. 4, which can equally illustrate a section along line C-C, D-D, and/or E-E in FIG. 2 or 3.

In other words, in one embodiment, FIG. 4 represents a section along line C-C in

FIG. 2, in one embodiment, additionally or alternatively, a section—if need be, scaled—along line D-D and/or a section—if need be, scaled—along line E-E in FIG. 2. In another embodiment, FIG. 4 represents a section along line C-C in FIG. 3, in one embodiment, additionally or alternatively, a section—if need be, scaled—along line D-D and/or a section—if need be, scaled—along line E-E in FIG. 3. Accordingly, in one embodiment in which FIG. 4 represents a section along line C-C, D-D, and/or E-E in FIG. 2, the third aspect, which is explained below is combined with the above-discussed first aspect of the honeycomb sizes varying in the axial direction. In another embodiment, in which FIG. 4 represents a section along line C-C, D-D, and/or E-E in FIG. 3, the third aspect explained below is realized with homogenous or (also) equally large honeycombs in the axial direction or without the above-explained first aspect. In one embodiment indicated by dashes in FIG. 5, the second aspect and the third aspect can be combined with each other, in particular also with the first aspect (compare the dashed contour in FIG. 5 as a section along line C-C, D-D, and/or E-E in FIG. 2) or without it (compare the dashed contour in FIG. 5 as a section along line C-C, D-D, and/or E-E in FIG. 3).

As can be seen from the extended and continuous section of FIG. 4 or the dashed section of FIG. 5, the common walls 12 of the honeycombs 11 each have a first radial wall section W1 and an adjoining second radial wall section W2 that is closer to the gap, the maximum wall thickness t2 of which is less than a maximum wall thickness t1 of the first wall section W1. In addition, the area of a front side 13 of these walls 12 facing the gap is smaller in each case than the cross-sectional area of the radial wall section W1 that is further away from the gap.

The cross-sectional area and maximum wall thickness t2 of the walls 12 in the second wall section W2 decrease in each case monotonically toward the front side 12 facing the gap.

The second wall section W2 extends in each case out of the front side 12 of the wall facing the gap and the first wall section that is further away from the gap extends out of the bottom 14 facing away from the gap.

Although, in the preceding description, exemplary embodiments were explained, it is noted that a large number of modifications are possible.

Thus, in the above, the first aspect of the honeycomb size varying in the axial direction was discussed in connection with the second aspect of the inclined walls (compare FIG. 5) and/or in connection with the third aspect of the wall thicknesses that are radially tapered with respect to the front sides 13 (compare the extended contour in FIG. 4 or the dashed counter in FIG. 5). In one embodiment, the first aspect can also be realized without the second aspect and the third aspect. This is indicated by dashes in FIG. 4.

Moreover, it is noted that that what are involved as examples are merely exemplary embodiments, which are not intended to limit the protective scope, the applications, and the construction in any way. Instead, the preceding description will give the person skilled in the art a guideline for the implementation of at least one of the exemplary embodiments, with it being possible to make diverse changes, in particular in regard to the function and arrangement of the described components, without leaving the protective scope that ensues from the claims and the combinations of features equivalent to these.

### LIST OF REFERENCE CHARACTERS

10 honeycomb seal (sealing element)
11 honeycomb
12 wall
13 (honeycomb/wall) front side
14 bottom
100 guide vane
101 platform
102 seal carrier
200 rotor (counter element)
210 sealing fin
220 rotating blade (counter element)
221 platform
A1 first axial section
A2 additional first axial section
B1-B3 second axial section
t1, t2 maximum wall thickness
W1 first radial wall section/radial wall section further away from the gap
W2 second wall section/tapered radial wall section
α inclination (angle)

1. A sealing element for sealing a radial gap relative to a counter element of a turbomachine, wherein the sealing element has a number of adjacent cells in the peripheral direction and/or in the axial direction, which are joined to one another by common walls, wherein an extension of a least one, in particular front-side, cross section of at least one cell in a first axial section of the sealing element in the peripheral direction and/or in the axial direction for sealing against a radial flange of the counter element is smaller than that in a second axial section that adjoins the first axial section upstream and/or in a second axial section of the sealing element that adjoins the first axial section downstream.

2. The sealing element according to claim 1, wherein an extension of at least one, front-side, cross section of at least one cell in another first axial section of the sealing element in the peripheral direction and/or in the axial direction for sealing against another radial flange of the counter element is smaller than that in a second axial section of the sealing element that adjoins the additional first axial section upstream and/or in a second axial section that adjoins the additional first axial section downstream.

3. The sealing element according to claim 1, wherein an axial length of the first and/or additional first axial section is at least 110% and/or at most 300% of an axial length of a front side of the radial flange of the counter element lying opposite to said axial length and/or at least 50% and/or at most 300% of the adjoining upstream and/or downstream second axial section.

4. The sealing element according to claim 1, wherein the extension of at least one, front-side, cross section of at least one cell in the first and/or additional first axial section in the peripheral direction and/or axial direction is at most 95% and/or at least 25% of the extension of the adjoining upstream and/or downstream second axial section.

5. The sealing element according to claim 1, wherein the sealing element has a number of adjacent cells in the peripheral direction and/or in the axial direction, which are joined to one another by common walls, wherein at least one free wall of at least one of the cells and/or at least one common wall of at least two of the cells is inclined against at least one radial wall section in the peripheral direction and/or axial direction.

6. The sealing element according to claim 1, wherein the wall is inclined against the wall section in or opposite to the direction of relative movement of the counter element and/or in or opposite to the flow direction of the turbomachine.

7. The sealing element according to claim 5, wherein the wall section extends out from a front side of the wall facing the gap and/or from a bottom of the cell facing away from the gap and/or over at least 5% of a radial height of the wall.

8. The sealing element according to claim 5, wherein a front side of the wall facing the gap is displaced in the peripheral direction and/or axial direction by at least 1% and/or by at most 100% of a radial wall height with respect to a connection cross section of the wall with a bottom of the cell.

9. The sealing element in accordance with claim 1, wherein the sealing element has a number of adjacent cells in the peripheral direction and/or axial direction, which are joined to one another by common walls, wherein at least one free wall of at least one of the cells and/or at least one common wall of at least two of the cells has a first radial wall section and an adjoining second radial wall section that is closer to the gap, the maximum wall thickness of which is less than a maximum wall thickness of the first wall section and/or has a front side facing the gap, the area of which is smaller than an area of at least one cross section, which is parallel to it, of a radial wall section that is further away from the gap.

10. The sealing element according to claim 9, wherein the cross-sectional area and/or maximal wall thickness of the wall in at least one tapered, second, wall section decreases toward the front side of the wall facing the gap, up to the front side, and/or monotonically.

11. The sealing element according to claim 9, wherein the tapered and/or second wall section extends out from a front side of the wall facing the gap and/or over at least 1% of a radial height of the wall, and/or the first wall section and/or the wall section that is further away from the gap extends out from a bottom of the cell facing away from the gap and/or over at least 50% of a radial height of the wall.

12. The sealing element according to claim 9, wherein the maximum wall thickness of the wall in the tapered and/or second wall section is at most 90% and/or at least 10% of the maximum thickness of the wall in the first wall section, and/or the area of the front side is at most 90% and/or at least 10% of the area of the cross section in the wall section that is further away from the gap.

13. The sealing element according to claim 1, wherein the cells are manufactured at least in part by free-forming, additive manufacturing, and/or at least in part from metal, a nickel-based and/or a cobalt-based alloy.

14. The sealing element according to claim 1, wherein a front side facing the gap of at least one of the cells is open, and/or at least one of the cells is closed by a bottom facing away from the gap, and/or at least one of the cells is joined to a housing element or a rotor element, to a vane platform or to a seal carrier of the turbomachine, that is formed integrally or detachably in a non-destructive manner or not detachably in a non-destructive manner, in a material bonded, friction-fitting, and/or form-fitting manner.

15. The sealing element according to claim 1, wherein the cells have at least in part polygonal, or hexagonal, cross sections.

16. The sealing element according to claim 1, wherein a counter element and a housing-fixed or rotor-fixed sealing element are configured and arranged within compressor stages or turbine stages for a gas turbine, for sealing a radial gap with respect to the rotor-fixed or housing-fixed counter element.

17. The sealing element according to claim 1, wherein at least one sealing element is configured and arranged in a turbomachine.

18. The sealing element according to claim 1, wherein the cells are manufactured at least in part by free-forming, in particular additive manufacturing.
